(19) United States
(12) Patent Application Publication
(10) Pub. No.: US 2026/0146905 A1
(43) Pub. Date: May 28, 2026

(54) IMPROVED OPTICAL FIBRE SENSING

(71) Applicant: VICTORIA LINK LIMITED, Wellington (NZ)

(72) Inventors: Rodney Alan Badcock, Wellington (NZ); Xiyong Huang, Wellington (NZ)

(73) Assignee: VICTORIA LINK LIMITED, Wellington (NZ)

(21) Appl. No.: 19/124,105

(22) PCT Filed: Oct. 24, 2023
(86) PCT No.: PCT/NZ2023/050111

§ 371 Date: Apr. 24, 2025

(30) Foreign Application Priority Data
Oct. 26, 2022 (AU) 2022903167

(51) Int. Cl. G01L 1/24; G01K 11/3206

(52) U.S. Cl. CPC G01L 1/246; G01K 11/3206

(57) ABSTRACT

Aspects of the technology provide a method/system of sensing a change in temperature and/or strain in an optical fibre comprising a substantially continuous or quasi-continuous fibre Bragg grating. A difference spectrum is determined between a reference reflected spectrum of the fibre Bragg grating and a monitored reflected spectrum. The difference spectrum is analysed to determine whether the optical fibre is experiencing a change of type a)—a temperature increase or an extension—or of type b)—a temperature decrease or a contraction. The technology may be applied to sensing a change in temperature and/or strain in a superconductor or detecting a risk of a quench in a superconductor.

### 1. FIELD OF THE TECHNOLOGY

The field of the technology relates to optical fibre sensing systems, devices and methods. In particular, the field of the technology relates to systems, devices and methods for sensing a change in temperature and/or strain. Furthermore, the technology may relate to sensing a change in temperature and/or strain in a length of superconducting material. Furthermore, the technology may relate to detecting a risk of a quench in a length of superconducting material.

### 2. BACKGROUND TO THE TECHNOLOGY

Superconducting circuits have a wide range of applications. Examples of applications for systems including superconducting circuits include (and are not limited to): superconducting magnets; flux pumps; fault current limiters; magnetic energy storage systems; space propulsion; nuclear fusion; nuclear magnetic resonance (NMR); magnetic resonance imaging (MRI); levitation; water purification and induction heating.

Field windings in high temperature superconducting (HTS) systems consist of significant lengths of high temperature superconducting material (e.g. ReBCO tape or wire) which may have inductances in the range of 1-10 H for megawatt-class systems. The detection of an impending quench in these windings is a significant challenge using conventional voltage detection methodology. Detecting an impending quench may need to occur in an electrically noisy environment (large AC magnetic and electric fields), have high localised sensitivity to temperature changes, operate reliably at cryogenic temperatures, and be cost economical.

Fibre Bragg grating (FBG) temperature sensors are good candidates for impending quench detection in HTS materials due to their low EMI sensitivity, light weight and small heat invasion. However, known FBG techniques suffer from drawbacks that render them unsuitable for some commercial applications.

PCT Patent Application No. PCT/NZ2019/050075 (published as PCT Publication No. WO 2020/005077) describes a continuous or quasi-continuous FBG sensing system and method that may be used to detect a possibly approaching quench in a superconducting system. A continuous or quasi-continuous FBG sensing system may behave like one ultra-long fiber Bragg grating (ULFBG), may be more sensitive and may respond to a temperature change faster than a discrete FBG. The ULFBG may therefore have useful application, for example to situations in which the location of the temperature or strain change is not of importance, e.g. hot-spot detection in HTS windings.

Tracking the peak shift of a FBG may be used to correlate with the change in strain or temperature. However, unlike the wavelength-division multiplexed array of FBGs, which have clearly defined peaks, the spectrum of ULFBGs are often broadened and ‘distorted’ due to strain or temperature distribution across the sensors. This implies that the temperature induced spectral change could occur anywhere in the spectrum in any form. For example, existing peaks could emerge, or new peaks could arise. Besides, spectral change could manifest itself as a variation in the spectrum shape without shifting the peaks or the creation of a distinct peak. Therefore, tracking the peak shift of a ULFBG may be less effective. In addition, due to the nature of the superimposed spectra, a temperature or strain induced change in the spectrum may be less perceptible, particularly if the magnitude of the change is relatively small.

The system and method of PCT/NZ2019/050075, which relies on summing up the absolute intensity change, is a possible method of processing the spectral data. However, this approach suffers from two major issues: since the algorithm processes the entire window of spectrum, 1) its signal to noise ratio (SNR) is limited; and 2) the integrated signal cannot distinguish between a temperature rise and fall.

Some other methods of detecting changes in optical fibres exist, but many suffer from one or more of the disadvantages of the system and method of PCT/NZ2019/050075 stated above, and may be ineffective when the magnitude of the change is relatively small.

### 3. OBJECT OF THE TECHNOLOGY

It is an object of the technology to provide an improved system, device and/or method of sensing a change in temperature and/or strain. Alternatively, it is an object of the technology to provide an improved optical fibre sensing system, device and/or method. Alternatively, it is an object of the technology to provide an improved system, device and/or method of sensing a change in temperature and/or strain in a length of superconducting material. Alternatively, it is an object of the technology to provide an improved system, device and/or method of detecting a risk of a quench in a length of superconducting material.

Alternatively, it is an object of the technology to at least provide the public with a useful choice.

### 4. SUMMARY OF THE TECHNOLOGY

According to certain aspects of the technology there is provided a system, device and/or method of sensing a change in temperature and/or strain. There may be provided a system, device and/or method of sensing a change in temperature and/or strain in an optical fibre. The optical fibre may be associated with, for example in thermal contact with, another object, system or device for which the change in temperature and/or strain is monitored.

According to one aspect of the technology there is provided a processor-implemented method of sensing a change in temperature and/or strain in an optical fibre comprising a substantially continuous or quasi-continuous fibre Bragg grating. The method may comprise receiving a reference reflected spectrum indicative of a reference reflection by the fibre Bragg grating of incident light provided into an end of the optical fibre. The method may further comprise receiving a monitored reflected spectrum, wherein the monitored reflected spectrum may be detected by the sensor from reflection by the fibre Bragg grating of incident light provided into the end of the optical fibre during monitoring. The method may further comprise determining a difference spectrum between the reference reflected spectrum and the monitored reflected spectrum. The method may further comprise analysing the difference spectrum to determine whether the optical fibre is experiencing a change of type a) or b), wherein a) is a temperature increase or an extension, and wherein b) is a temperature decrease or a contraction. An extension may be considered to be a positive strain and a contraction may be considered to be a negative strain.

In some forms, analysing the difference spectrum may comprise detecting a shape of the difference spectrum and determining from the shape of the difference spectrum whether the change is type a) or b).

In some forms, the method may further comprise determining a measure of spectral change of the monitored reflected spectrum and using the measure of spectral change to determine whether the change is type a) or b).

In some forms, the method may further comprise determining a rate of spectral change of the monitored reflected spectrum and using the rate of spectral change to determine a rate of temperature change and/or a rate of strain change.

In some forms, the method may further comprise determining a measure of an average of the monitored reflected spectrum and using the measure of the average to determine whether the change is type a) or b).

In some forms, the method may further comprise determining a direction of change of the measure of the average of the monitored reflected spectrum to determine whether the change is type a) or b).

In some forms, the method may further comprise determining the measure of spectral change from a sub-set of the monitored reflected spectrum.

In some forms, the sub-set of the monitored reflected spectrum may comprise one or more ranges in the monitored reflected spectrum through which the magnitude of the corresponding difference spectrum exceeds a noise threshold.

In some forms, if the difference spectrum is determined to comprise a plurality of ranges in the monitored reflected spectrum through which the magnitude of the corresponding difference spectrum exceeds the noise threshold, the method may further comprise determining the measure of spectral change for each of the ranges in the monitored reflected spectrum.

In some forms, the method may further comprise performing a sum of each of the measures of spectral change to calculate a summed measure of spectral change.

In some forms, the method may further comprise determining the measure of spectral change if the difference spectrum is determined to be indicative of a saturated spectrum.

In some forms, the method may further comprise signalling the change. For example, the method may further comprise signalling the change if the change in temperature and/or the strain exceeds a threshold.

In some forms, the reference reflected spectrum may be indicative of reflection of the incident light when the optical fibre is in a steady-state temperature and strain condition.

In some forms, the step of analysing the difference spectrum may be performed if the difference spectrum exceeds a noise threshold.

In some forms, the method may further comprise determining if the difference spectrum exceeds the noise threshold by: receiving a reflected spectrum over a period of time, wherein the reflected spectrum is detected by the sensor from reflection by the fibre Bragg grating of incident light provided into the end of the optical fibre, and wherein the optical fibre is in a steady-state temperature and strain condition for the period of time; determining a noise spectrum from the received reflected spectrum over the period of time; and comparing the difference spectrum to the noise spectrum. The noise spectrum may be determined a plurality of times, for example periodically.

According to another aspect of the technology there is provided an optical fibre sensing system comprising an optical fibre comprising a substantially continuous or quasi-continuous fibre Bragg grating. The optical fibre sensing system may further comprise a light source for providing incident light to an end of the optical fibre. The optical fibre sensing system may further comprise a sensor for detecting a reflected spectrum of the incident light from the optical fibre. The optical fibre sensing system may further comprise a processor configured to monitor the optical fibre by performing a method. The method may comprise receiving a reference reflected spectrum of the incident light from the optical fibre. The method may further comprise receiving a monitored reflected spectrum of the incident light from the optical fibre. The method may further comprise determining a difference spectrum between the reference reflected spectrum and the monitored reflected spectrum. The method may further comprise analysing the difference spectrum to determine whether the optical fibre is experiencing a change of type a) or b), wherein a) is a temperature increase or an extension, and wherein b) is a temperature decrease or a contraction.

In certain forms, the fibre Bragg grating may have a grating period that is substantially the same along the length of the optical fibre when the optical fibre is in a steady-state temperature and strain condition. In other forms, the fibre Bragg grating may have a grating period that varies along the length of the optical fibre when the optical fibre is in a steady-state temperature and strain condition.

In certain forms, the fibre Bragg grating may have a reflectivity that is the same along the length of the optical fibre when the optical fibre is in a steady-state temperature and strain condition. Alternatively, the fibre Bragg grating may have a reflectivity that varies along the length of the optical fibre when the optical fibre is in a steady-state temperature and strain condition. For example, the optical fibre may comprise a quasi-continuous fibre Bragg grating comprising a plurality of fibre Bragg gratings, each separated by a gap, and the size of the gap may vary along the length of the optical fibre.

According to another aspect of the technology there is provided a processor-implemented method of sensing a change in temperature and/or strain in an optical fibre comprising a substantially continuous or quasi-continuous fibre Bragg grating. The method may comprise receiving a reference reflected spectrum indicative of a reference reflection by the fibre Bragg grating of incident light provided into an end of the optical fibre. The method may further comprise receiving a monitored reflected spectrum, wherein the monitored reflected spectrum may be detected by the sensor from reflection by the fibre Bragg grating of incident light provided into the end of the optical fibre during monitoring. The method may further comprise determining a difference spectrum between the reference reflected spectrum and the monitored reflected spectrum. The method may further comprise analysing the difference spectrum to determine whether the optical fibre is experiencing: a change in temperature and, if so, whether the temperature change is a temperature increase or decrease; or a strain and, if so, whether the strain is an extension or contraction.

According to another aspect of the technology there is provided an optical fibre sensing system comprising an optical fibre comprising a substantially continuous or quasi-continuous fibre Bragg grating. The optical fibre sensing system may further comprise a light source for providing incident light to an end of the optical fibre. The optical fibre sensing system may further comprise a sensor for detecting a reflected spectrum of the incident light from the optical fibre. The optical fibre sensing system may further comprise a processor configured to monitor the optical fibre by performing a method. The method may comprise receiving a reference reflected spectrum of the incident light from the optical fibre. The method may further comprise receiving a monitored reflected spectrum of the incident light from the optical fibre. The method may further comprise determining a difference spectrum between the reference reflected spectrum and the monitored reflected spectrum. The method may further comprise analysing the difference spectrum to determine whether the optical fibre is experiencing: a change in temperature and, if so, whether the temperature change is a temperature increase or decrease; or a strain and, if so, whether the strain is an extension or contraction.

According to another aspect of the technology there is provided a method of sensing a change in temperature and/or strain in a length of superconducting material. The length of superconducting material may be positioned in association with, for example in thermal contact with, an optical fibre. The optical fibre may comprise a substantially continuous or quasi-continuous fibre Bragg grating. The method may comprise receiving a reference reflected spectrum indicative of a reference reflection by the fibre Bragg grating of incident light provided into an end of the optical fibre. The method may further comprise receiving a monitored reflected spectrum, wherein the monitored reflected spectrum may be detected by the sensor from reflection by the fibre Bragg grating of incident light provided into the end of the optical fibre during monitoring. The method may further comprise determining a difference spectrum between the reference reflected spectrum and the monitored reflected spectrum. The method may further comprise analysing the difference spectrum to determine whether the optical fibre is experiencing: a change in temperature and, if so, whether the temperature change is a temperature increase or decrease; or a strain and, if so, whether the strain is an extension or contraction.

According to another aspect of the technology there is provided a system of sensing a change in temperature and/or strain in a length of superconducting material. The length of superconducting material may be positioned in association with, for example in thermal contact with, an optical fibre. The optical fibre may comprise a substantially continuous or quasi-continuous fibre Bragg grating. The optical fibre sensing system may further comprise a light source for providing incident light to an end of the optical fibre. The optical fibre sensing system may further comprise a sensor for detecting a reflected spectrum of the incident light from the optical fibre. The optical fibre sensing system may further comprise a processor configured to monitor the optical fibre by performing a method. The method may comprise receiving a reference reflected spectrum of the incident light from the optical fibre. The method may further comprise receiving a monitored reflected spectrum of the incident light from the optical fibre. The method may further comprise determining a difference spectrum between the reference reflected spectrum and the monitored reflected spectrum. The method may further comprise analysing the difference spectrum to determine whether the optical fibre is experiencing: a change in temperature and, if so, whether the temperature change is a temperature increase or decrease; or a strain and, if so, whether the strain is an extension or contraction.

According to another aspect of the technology there is provided a method of detecting a risk of a quench in a length of superconducting material. The length of superconducting material may be positioned in association with, for example in thermal contact with, an optical fibre. The optical fibre may comprise a substantially continuous or quasi-continuous fibre Bragg grating. The method may comprise receiving a reference reflected spectrum indicative of a reference reflection by the fibre Bragg grating of incident light provided into an end of the optical fibre. The method may further comprise receiving a monitored reflected spectrum, wherein the monitored reflected spectrum may be detected by the sensor from reflection by the fibre Bragg grating of incident light provided into the end of the optical fibre during monitoring. The method may further comprise determining a difference spectrum between the reference reflected spectrum and the monitored reflected spectrum. The method may further comprise analysing the difference spectrum to determine whether the optical fibre is experiencing: a change in temperature and, if so, whether the temperature change is a temperature increase or decrease; or a strain and, if so, whether the strain is an extension or contraction.

In some forms, the method may comprise detecting the risk of the quench in a length of superconducting material if there is detected an increase in temperature and/or strain in the optical fibre. In some forms, the method may comprise detecting the risk of the quench if the magnitude of the increase and/or the rate of increase in temperature and/or strain exceeds a certain threshold, or if an increase of the rate of increase in temperature and/or strain exceeds a certain threshold. The method may further comprise generating a signal, for example an alert, if one or more of the thresholds are exceeded.

According to another aspect of the technology there is provided a system of detecting a risk of a quench in a length of superconducting material. The length of superconducting material may be positioned in association with, for example in thermal contact with, an optical fibre. The optical fibre may comprise a substantially continuous or quasi-continuous fibre Bragg grating. The optical fibre sensing system may further comprise a light source for providing incident light to an end of the optical fibre. The optical fibre sensing system may further comprise a sensor for detecting a reflected spectrum of the incident light from the optical fibre. The optical fibre sensing system may further comprise a processor configured to monitor the optical fibre by performing a method. The method may comprise receiving a reference reflected spectrum of the incident light from the optical fibre. The method may further comprise receiving a monitored reflected spectrum of the incident light from the optical fibre. The method may further comprise determining a difference spectrum between the reference reflected spectrum and the monitored reflected spectrum. The method may further comprise analysing the difference spectrum to determine whether the optical fibre is experiencing: a change in temperature and, if so, whether the temperature change is a temperature increase or decrease; or a strain and, if so, whether the strain is an extension or contraction.

In some forms, the method may comprise detecting the risk of the quench in a length of superconducting material if there is detected an increase in temperature and/or strain in the optical fibre. In some forms, the method may comprise detecting the risk of the quench if the magnitude of the increase and/or the rate of increase in temperature and/or strain exceeds a certain threshold, or if an increase of the rate of increase in temperature and/or strain exceeds a certain threshold. The method may further comprise generating a signal, for example an alert, if one or more of the thresholds are exceeded.

Further aspects of the technology, which should be considered in all its novel aspects, will become apparent to those skilled in the art upon reading of the following description which provides at least one example of a practical application of the technology.

### 5. BRIEF DESCRIPTION OF THE DRAWINGS

One or more embodiments of the technology will be described below by way of example only, and without intending to be limiting, with reference to the following drawings, in which:

FIG. 1 is a schematic illustration of a fibre Bragg grating sensor according to one form of the technology;

FIG. 2 is a schematic illustration of an exemplary processing system according to one form of the technology;

FIG. 3 is a schematic illustration of the fibre Bragg grating sensor of FIG. 1 when a section of the optical fibre is subject to a change in temperature and/or strain;

FIG. 3A is a schematic illustration of a fibre Bragg grating sensor According to another form of the technology when a section of the optical fibre is subject to a change in temperature and/or strain;

FIG. 4A-D are illustrations of difference spectra that may be generated in different scenarios according to certain forms of the technology;

FIG. 5 is a flow chart of an exemplary method of sensing a change in temperature and/or strain in an optical fibre, and consequently detecting an impending quench in a length of superconducting material according to one form of the technology;

FIGS. 6A-C are graphs of exemplary reference reflected spectra for three different optical fibres obtained through experiments of a method according to certain forms of the technology;

FIGS. 7A-C are graphs of exemplary noise spectra obtained from the three difference optical fibres during the aforementioned experiments;

FIG. 8A illustrates the variation in temperature over time to which two of the optical fibres are subjected in the previously mentioned experiments;

FIGS. 8B, 8C are graphs illustrating the changes in the difference spectra over time for the two optical fibres mentioned in relation to FIG. 8A;

FIG. 9 illustrates the variation in temperature over time to which the optical fibres are subjected in the previously described experiments and the change in the determined centroid wavelength over time;

FIG. 10A is a graph indicating the progress in temperature change over time for an optical fibre in an experiment of a method according to one form of the technology;

FIG. 10B is a graph illustrating the changes in the difference spectrum over time for the optical fibre mentioned in relation to FIG. 10A;

FIG. 10C is a colour map illustrating the changes in the difference spectrum over time for the optical fibre mentioned in relation to FIG. 10A; and

FIG. 11 illustrates changes in wavelength shifts of spectral centroids and changes in temperature for the optical fibre of the experiment mentioned in relation to FIG. 10A.

### 6. DETAILED DESCRIPTION OF EXEMPLARY FORMS OF THE TECHNOLOGY

### 6.1. Continuous/Quasi-Continuous Fibre Bragg Grating Sensor

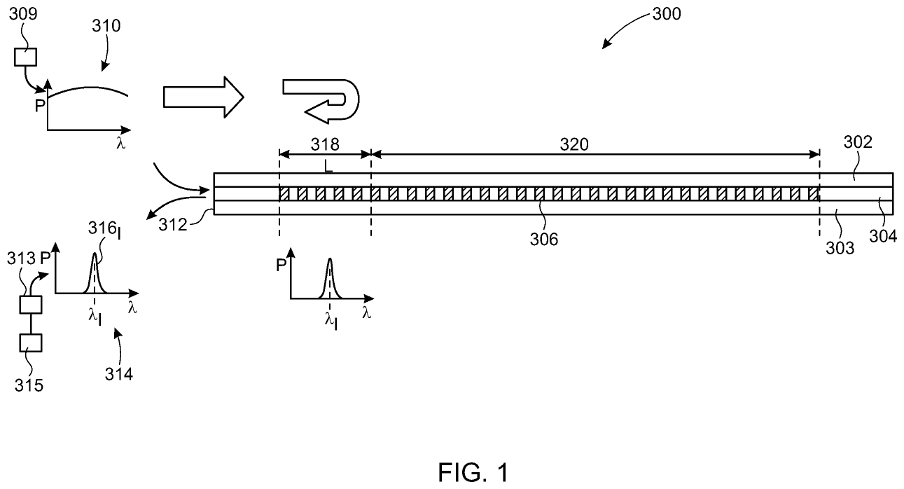

FIG. 1 shows a schematic of a Fibre Bragg Grating (FBG) sensing system 300 according to a form of the technology.

### 6.1.1. Optical Fibre

The FBG sensor may comprise an optical fibre 302 having cladding 303 and a core 304. A grating 306 may be written into the core 304 of the optical fibre 302.

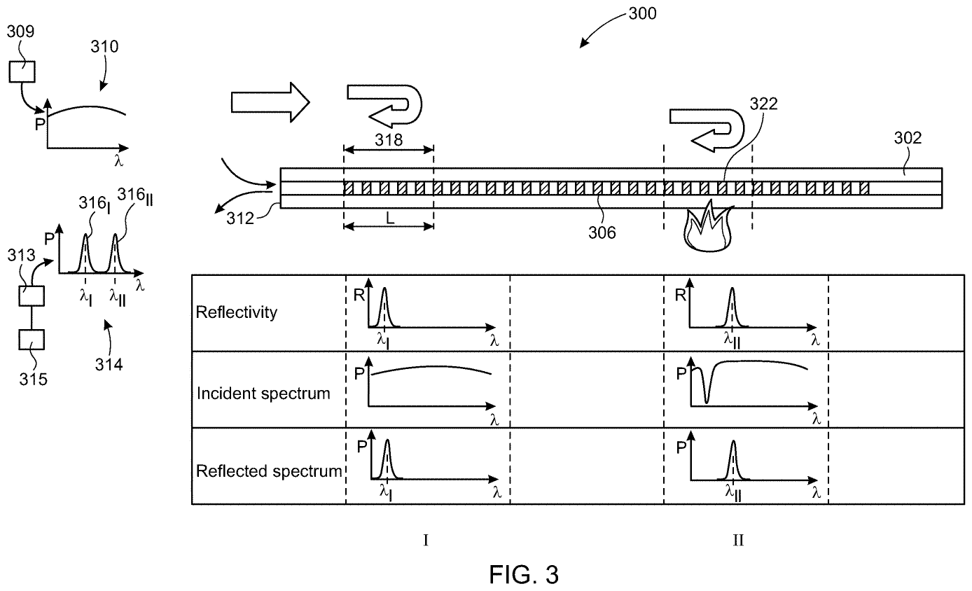

The grating 306 may have a grating period A that modulates the refractive index of the core 304. In this specification, the term “grating period” should be understood to refer to this spacing. The grating period Λ is labelled on FIG. 3A in relation to another form of the technology. The grating 306 may reflect light of a certain wavelength, and may transmit other wavelengths.

In the form of FIG. 1, the fibre Bragg grating 306 may have a grating period Λ that is substantially the same along the length of the optical fibre 302 when the optical fibre 302 is in a steady-state temperature and strain condition. An upstream portion 318 of the optical fibre 302 may have an attenuation length L that is adapted to reflect incident light 310 to the sensor 313 at a first steady-state wavelength λ_{II}. A downstream portion 320 of the optical fibre 302 may be adapted to reflect light to the sensor 313 when a change in temperature and/or strain at the downstream portion 320 causes a portion of the fibre Bragg grating 306 to reflect light to the sensor at a second wavelength λ_{II} other than the steady-state wavelength λ_{I} and at a second intensity. In the steady-state temperature and strain condition, the downstream portion 320 may be adapted to reflect no light at the second wavelength λ_{II}, or may be adapted to reflect a first intensity of light at the second wavelength λ_{I} that is lower than the second intensity.

In other forms, the grating period may vary along the length of the optical fibre 302 when the optical fibre 302 is in a steady-state temperature and strain condition.

In certain forms, the fibre Bragg grating 306 may extend along substantially the entire length of the optical fibre 302. Additionally, or alternatively, by having varying Bragg wavelengths along the length of the optical fibre 302 when the optical fibre 302 is in a steady-state temperature and strain condition, the total sensing length of the fibre Bragg grating can be improved by enabling the use of multiple monitoring wavelengths.

In certain forms, the fibre Bragg grating 306 may have varying reflectivity along the length of the optical fibre 302 when the optical fibre 302 is in a steady-state temperature and strain condition.

Forms of the technology include examples in which the fibre Bragg grating is a continuous FBG and examples in which the fibre Bragg grating is a quasi-continuous FBG. The term “continuous fibre Bragg grating” may be used to refer to a FBG in which the grating period Λ of the modulated refractive index is substantially continuous along the length of the grating 306. A continuous FBG may be formed from a plurality of short fibre Bragg gratings in series. The term “quasi-continuous fibre Bragg grating” may be used to refer to a FBG in which the optical fibre comprises a plurality of short fibre Bragg gratings in series with small gaps between each grating, which again forms a substantially continuous fibre Bragg grating. An example of a quasi-continuous fibre Bragg grating is illustrated in FIG. 3A. In this figure, the gap between each fibre Bragg grating 306 is labelled as “FBG gap”. The gaps between the short fibre Bragg gratings in a quasi-continuous FBG may be less than the length of the gratings. For example, in one form, the short fibre Bragg gratings may be about 9 mm long and the short fibre Bragg gratings may be spaced apart by a gap of about 1 mm. A series of short fibre Bragg gratings may be more feasible to manufacture for a substantially continuous FBG. In alternative forms, the fibre Bragg gratings may be any suitable length, for example about 20 mm long or about 30 mm long. The fibre Bragg gratings may be spaced apart by any suitable gap, for example, 5, 10, 20, or 50 mm apart.

In certain forms, the number of quasi-continuous FBGs may be selected so that, when a spectrum of incident light 310 is shone in the optical fibre 302, the entire spectrum is not saturated in the steady-state temperature and strain condition of the optical fibre 302. For example, the optical fibre 302 may be configured to avoid having a high number of FBGs with the same or similar grating period, and consequently Bragg wavelength. This configuration of optical fibre 302 may have a higher sensitivity than an optical fibre 302 in which the spectrum saturates during use.

### 6.1.1.1. Attenuation Length

In certain forms, the upstream portion 318 of the optical fibre 302 may be defined by the attenuation length L of the fibre Bragg grating 306. The attenuation length L may be the distance from the upstream end 312 of the optical fibre 302 at which 1/e (about 63%) of the incident light 310 at the steady-state wavelength λ_{I} is reflected. At a distance of 2L from the upstream end 312, about 86% of the incident light 310 at the steady-state wavelength λ_{I} may be reflected. At a distance of 6L from the upstream end 312, about 99.8% of the incident light 310 at the steady-state wavelength λ_{I} may be reflected.

In certain forms of the technology, the optical fibre 302 may be longer than the attenuation length L of the fibre Bragg grating 306. In one example, the optical fibre 302 is at least twice the attenuation length L of the fibre Bragg grating 306. In another example, the optical fibre 302 is at least 6 times the attenuation length L of the fibre Bragg grating 306. In another example, the optical fibre 302 is at least 1,000 times the attenuation length L of the fibre Bragg grating 306. In another example, the optical fibre 302 is at least 10,000 times the attenuation length L of the fibre Bragg grating 306. In another example, the optical fibre 302 is at least 100,000 times the attenuation length L of the fibre Bragg grating 306.

### 6.1.1.2. Reflectivity

The attenuation length L may be inversely proportional to the reflectivity of the FBG 306. Higher reflectivity per unit length of the FBG 306 may result in a shorter attenuation length L. Higher reflectivity may advantageously improve the resolution that can be detected by a sensor 313. However, some known continuous FBG sensors may require low overall reflectivity to enable the sensor to detect a signal along the length of the optical fibre. Known continuous FBG sensors typically have an overall reflectivity of less than 20% along the entire length of the fibre.

In certain forms, the overall reflectivity of the fibre Bragg grating 306 may be greater than 0.1% along the entire length of the optical fibre 302. In one example, the overall reflectivity of the fibre Bragg grating 306 may be greater than 1%. In one example, the overall reflectivity of the fibre Bragg grating 306 may be greater than 10%. In one example, the overall reflectivity of the fibre Bragg grating 306 may be greater than 20%. In another example, the overall reflectivity of the fibre Bragg grating 306 may be greater than 50%. In another example, the overall reflectivity of the fibre Bragg grating 306 may be greater than 95%. In another example, the overall reflectivity of the fibre Bragg grating 306 approaches 100%.

As stated above, in certain forms, the fibre Bragg grating 306 may have varying reflectivity along the length of the optical fibre 302 when the optical fibre 302 is in a steady-state temperature and strain condition.

### 6.1.1.3. FBG Gaps

FIG. 3A illustrates a form of the technology in which the fibre Bragg grating is a quasi-continuous fibre Bragg grating and there is a gap between each fibre Bragg grating 306 referred to as the “FBG gap”. In such forms, the gap between FBGs 306 is proportional to the attenuation length L. Therefore, the larger the gap between the fibre Bragg gratings 306, the longer the attenuation length. However, as explained above, the sensing resolution is reduced as the attenuation length L increases. Depending on the requirement of the application, the FBG gaps may be selected according to the needs. Even in a single optical fibre 302, the size of the gaps may vary along the length of the optical fibre 302. The manner in which the size of the gaps vary along the length of the optical fibre 302 may be selected according to the needs of resolution of the application.

### 6.1.2. Light Source & Sensor

During use, an incident light source 309 may provide a spectrum of incident light 310 to an upstream end 312 of the sensing system 300. A “spectrum” may be understood to be the variation in a quality of light across a range of different wavelengths and/or frequencies. In some forms, the quality of the light may be intensity. Some of the incident light 310 may be transmitted to a downstream end of the fibre 302 to provide a transmitted spectrum. Some of the incident light 310 may be reflected by the grating 306 to provide a reflected spectrum 314. A sensor 313 may detect the reflected spectrum 314. The spectrum 314 of the back-reflected light may have a characteristic shape, for example a curve in the shape of a peak 316 with a centre wavelength, which is known as the Bragg wavelength λ_{II}.

Consequently, in forms of the technology in which the optical fibre 302 comprises fibre Bragg gratings 306 that have a grating period Λ that is substantially the same along the length of the optical fibre 302 when the optical fibre 302 is in a steady-state temperature and strain condition, the Bragg wavelength of each fibre Bragg grating 306 may be substantially the same. In forms of the technology in which the optical fibre 302 comprises fibre Bragg gratings 306 that have a grating period that varies along the length of the optical fibre 302 when the optical fibre 302 is in a steady-state temperature and strain condition, the Bragg wavelength of each fibre Bragg grating 306 may likewise vary.

In certain forms, the sensor 313 may be a wavelength division multiplexing (WDM) sensor. In alternative forms, the sensor 313 may be any suitable sensor, such as an optical spectrum analyser or a spectrometer.

### 6.1.3. Processor

The processor 315 may be configured to analyse the reflected spectrum that is detected by the sensor 313. The processor 315 may be configured, in conducting this analysis, to determine when a portion of the fibre Bragg grating 306 is experiencing a change in temperature and/or strain. How this is achieved in some forms of the technology is described in more detail later in this specification.

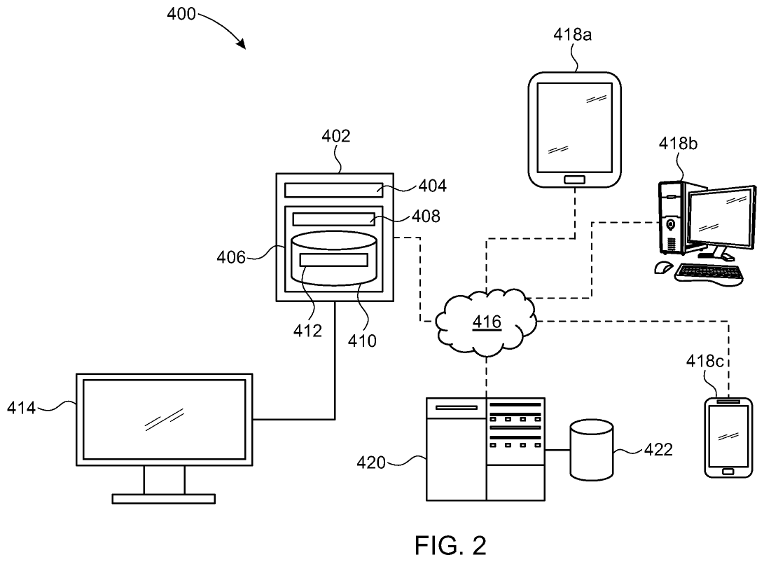

FIG. 2 is a schematic illustration of an exemplary processing system 400 according to one form of the technology. In certain forms, the processor 315 may be comprised as part of processing system 400.

Processing system 400 may comprise a hardware platform 402 that manages the collection and processing of data from one or more devices, which may include sensors and user devices. The hardware platform 402 may have a processor 404 (which may be processor 315 of FIG. 1), memory 406, and other components typically present in such computing devices. The hardware platform 402 may be local to the device(s) or it may be remote from the device(s) and receive the data over a suitable communications link. In the exemplary form of the technology illustrated, the memory 406 stores information accessible by processor 404, the information including instructions 408 that may be executed by the processor 404 and data 410 that may be retrieved, manipulated or stored by the processor 404. The memory 406 may be of any suitable means known in the art, capable of storing information in a manner accessible by the processor 404, including a computer-readable medium, or other medium that stores data that may be read with the aid of an electronic device.

The processor 404 may be any suitable device known to a person skilled in the art. Although the processor 404 and memory 406 are illustrated as being within a single unit, it should be appreciated that this is not intended to be limiting, and that the functionality of each as herein described may be performed by multiple processors and memories, that may or may not be remote from each other or from the processing system 400. The instructions 408 may include any set of instructions suitable for execution by the processor 404. For example, the instructions 408 may be stored as computer code on the computer-readable medium. The instructions may be stored in any suitable computer language or format. Data 410 may be retrieved, stored or modified by processor 404 in accordance with the instructions 410. The data 410 may also be formatted in any suitable computer readable format. Again, while the data is illustrated as being contained at a single location, it should be appreciated that this is not intended to be limiting—the data may be stored in multiple memories or locations. The data 410 may also include a record 412 of control routines for aspects of the system 400. The processor 404 may be a central processing unit (CPU), a graphics processing unit (GPU), a digital signal processor (DSP), an application specific integrated circuit (ASIC), a radio-frequency integrated circuit (RFIC), or any suitable combination thereof.

The hardware platform 402 may communicate with a display device 414 to display the results of processing of the data. The hardware platform 402 may additionally or alternatively communicate over a network 416 with one or more other devices (for example user devices, such as a tablet computer 418a, a personal computer 418b, or a smartphone 418c, or other devices including sensors, such as current sensors and voltage sensors, and current source 202), or one or more server devices 320 having associated memory 322 for the storage and processing of data collected by the local hardware platform 402. It should be appreciated that the server 320 and memory 322 may take any suitable form known in the art, for example a “cloud-based” distributed server architecture. The network 416 may comprise various configurations and protocols including the Internet, intranets, virtual private networks, wide area networks, local networks, private networks using communication protocols proprietary to one or more companies, whether wired or wireless, or a combination thereof.

6.1.4. Structure being Sensed

In certain forms of the technology, the FBG sensing system 300 may be configured to sense changes in temperature and/or strain in another structure, system or component. For example, the FBG sensing system 300 may be configured to sense changes in temperature and/or strain or a length of superconducting material, for example a coil or winding formed from a HTS material.

In certain forms, the optical fibre 302 may be configured to be positioned in association with, for example in intimate thermal and/or mechanical contact with, the object that it is measuring, for example, HTS tape/wire. For example, the optical fibre 302 may be adhered to the object using any suitable adhesive. The adhesive may be a removable adhesive, such as vacuum grease, GE vanish, or kapton tape. The adhesive may be a permanent adhesive, such as epoxy. In certain forms, the adhesive may be specifically designed to adhere effectively at cryogenic temperatures. In certain forms, the optical fibre 302 is adhered along a substantial length of the object, or a substantial part of the length of the object that is desired to be monitored. In other forms, the optical fibre 302 may be in thermal contact with the object without being adhered to the object, although the FBG sensing system 300 may be more sensitive to temperature changes when adhesion is used.

### 6.2. Response of Optical Fibre to Change of Temperature/Strain

As explained earlier, the upstream portion 318 of the optical fibre 302 effectively ‘shadows’ the downstream portion 320 of the fibre 302 from incident light at the steady-state wavelength λ_{I}. When the optical fibre 302 is in a steady-state condition (uniform temperature and strain), the downstream portion 320 of the optical fibre 302 reflects substantially no light and the reflected spectrum 314 that is detected by the sensor 313 and analysed by the processor 315 has a single peak 3161. For example, the reflection spectrum 314 may have a broad quasi-Gaussian shape.

FIG. 3 is a schematic illustration of the Fibre Bragg Grating (FBG) sensing system 300 of FIG. 1 when a section 322 of the FBG 306 is subject to a change in temperature and/or strain. FIG. 3A is a schematic illustration of another form of the technology in which the optical fibre 302 comprises a quasi-continuous fibre Bragg grating and a section is also subject to a change in temperature and/or strain. In these scenarios, the refractive index of the section 322 may change. Light may be reflected by the section 322 at a second wavelength λ_{II} that is different to the steady-state wavelength λ_{I} and an additional peak 316_{II} may appear in the reflected spectrum 314 that is detected by the sensor 313 and analysed by the processor 315. The additional peak 316_{II} may also have a broad quasi-Gaussian shape.

The section 322 may be anywhere along the length of the FBG 306, including within the attenuation length L. The fibre Bragg grating 306 may be adapted to reflect light to the sensor at the second wavelength λ_{II} when a change in temperature and/or strain occurs in the upstream portion 318 (having attenuation length L) of the optical fibre 302. When the section 322 is within the upstream portion 318, light is reflected at the second wavelength λ_{II} that is different to the steady-state wavelength λ_{I}. Because the downstream portion 320 of the optical fibre 302 has the same Bragg condition as the upstream portion 318, light will continue to be reflected at the steady-state wavelength λ_{I} when the section 322 is within the upstream portion 318. The reflected spectrum 314 will be substantially the same for a section 322 within the upstream portion 318 as for a section 322 within the downstream portion 320.

The peaks 316_{I} and 316_{II} may not appear in the reflected spectrum 314 as distinctively as shown in FIGS. 3 and 3A. For example, small changes in temperature and/or small strains may cause the second wavelength λ_{II} to differ only slightly from the steady-state wavelength λ_{I}, for example by an amount that is less than, or of a similar order of magnitude to, the approximately breadth of the peaks 316_{I} and 316_{II}. This makes changes in the reflected spectrum 314 challenging to detect and challenging to characterise.

In addition, when the optical fibre 302 of the FBG sensing system 300 is bonded to a structure being sensed, e.g. a HTS coil at cryogenic temperatures, the random strain distribution along the FBG 306 may cause the original single peaked quasi-Gaussian spectrum to be broadened and distorted. Therefore, temperature-induced spectral changes may occur anywhere in the spectrum in any form, which again creates challenges for detecting and characterising changes.

### 6.3. Detection of Change of Temperature/Strain

In certain forms of the technology, the responses of the optical fibre 302 to a change in temperature and/or strain conditions may be used to sense a change in temperature and/or strain, for example in a structure with which the optical fibre 302 is positioned in intimate thermal and/or mechanical contact. In certain forms, the structure may be a length of superconducting material, including a length of HTS material, for example a winding in a superconducting system. In such forms, the detection of an increase in temperature and/or a positive change in strain (which may be an expansion of the length of superconducting material) may indicate an approaching quench of the length of superconducting material.

Exemplary methods and systems of detecting changes in temperature and/or strain according to certain forms of the technology will now be described. In certain forms, the steps of the method may be performed by processor 315 unless the context clearly indicates otherwise. The exemplary methods and systems described may be advantageous over some prior art methods and systems as they may be able to sense changes in temperature and/or strain of relatively small magnitudes in comparison to what prior systems/methods may sense, and they may be able to determine the sign of the change, i.e. whether the change in temperature is a temperature increase or decrease, or whether the strain is positive (i.e. an extension) or negative (i.e. a contraction).

It should be understood that the exemplary methods and systems described may determine between a sensed change in the optical fibre 302 of a type a) and a sensed change in the optical fibre 302 of a type b). A change of type a) may be an increase in temperature or a positive strain (i.e. an extension). A change of type b) may be a decrease in temperature or a negative strain (i.e. an contraction). Unless otherwise stated, the exemplary methods and systems may not be able to distinguish the nature of the change within each type, i.e. whether the change is a change in temperature or a strain. However, distinguishing the nature of the change within each type may not be necessary in certain applications of the exemplary forms, for example in some applications of detecting hotspots in HTS magnets.

### 6.3.1. Difference Spectrum

In certain forms of the technology, changes in temperature and/or strain conditions of the optical fibre 302 may be detected by analysing changes in the reflected spectrum 314 detected by the sensor 313 that occur when the temperature and/or strain of the optical fibre 302 changes. To analyse these changes, in certain forms, a difference spectrum 430 may be generated and the difference spectrum 430 may be analysed to determine what changes in the optical fibre 302 are occurring or have occurred.

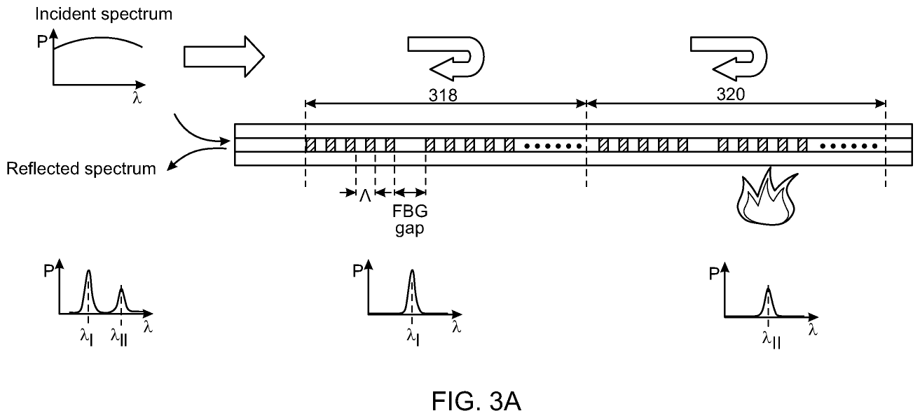

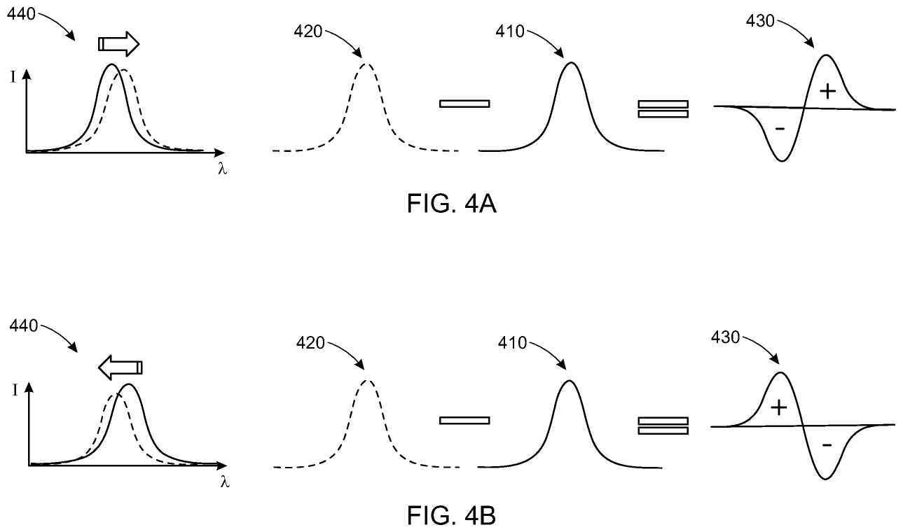

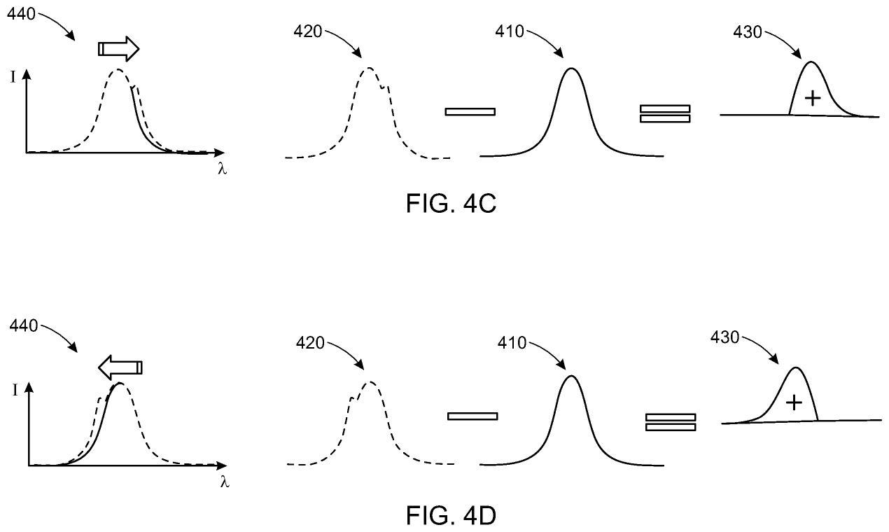

FIGS. 4A-4D illustrate methods of determining a difference spectrum 430 according to certain forms of the technology. In each of FIGS. 4A-4D, there is illustrated a reference reflected spectrum 410, a monitored reflected spectrum 420 and a difference spectrum 430. In addition, graph 440 plots the reference reflected spectrum 410 and the monitored reflected spectrum 420 on the same axes so they can be compared.

Each of the reference reflected spectrum 410 and monitored reflected spectrum 420 are reflected spectra 314 detected by the sensor 313 as described earlier. While the graphs 440 of FIGS. 4A-4D indicate that these spectra are variations in the intensity of light with wavelength, in other forms the spectra may take the form of variations in the intensity of light with frequency. In some forms, a wavelength spectrum or a frequency spectrum may be determined by applying a Fourier transform to another spectrum, for example such a conversion may occur before and/or after the steps of analysing the spectrum. In still other forms, some characteristic indicative of the amount of light received other than intensity may be used. In the following description, forms of the technology will be described in which the spectra are intensity against wavelength, but it will be understood that, in other forms, other types of spectra may alternatively be used.

The reference reflected spectrum 410 may be indicative of reflection by the FBG 306 of incident light 310 provided into an end of the optical fibre 302 by light source 309. In some forms, the reference reflected spectrum 410 may be indicative of the behaviour of the optical fibre 302 when it is in a steady-state state, for example steady-state temperature and strain condition. The reference reflected spectrum 410 may be the reflected spectrum 314 measured by the sensor 313 at a particular time when the optical fibre 302 is in such a condition. Alternatively, the reference reflected spectrum 410 may be generated from one or more reflected spectra 314 when the optical fibre 302 is in the steady-state condition. For example, the reference reflected spectrum 410 may be an average of a plurality of reflected spectra 314 sensed over a period of time. In other forms, the reference reflected spectrum 410 may be a reflected spectrum 314 measured by the sensor 313 at some earlier time than the monitored reflected spectrum 420. In some forms, the sensor 313 may be configured to detect the reflected spectrum 314 at a plurality of detection times t=1, 2, 3, . . . , for example detection times at regular intervals, and, if the monitored reflected spectrum 420 is the reflected spectrum at time t, the reference reflected spectrum 410 may be the reflected spectrum at time t−n, for example n=1 or 2 or 3, etc. In a further alternative form, the reflected spectrum 420 may be an average of a plurality of earlier reflected spectra, for example an average of the spectra detected at times t−1, t−2, t−3, t−4 and t−5.

The monitored reflected spectrum 420 may be the reflected spectrum 314 from the FBG 306 of incident light 310 provided into the same end of the optical fibre 302 by light source 309. The monitored reflected spectrum 420 may be detected on a recurring basis, for example at regular intervals.

The difference spectrum 430 may be a spectrum indicative of a difference between the reference reflected spectrum 410 and the monitored reflected spectrum 420. In some forms, the difference spectrum 430 may be generated by subtracting the reference reflected spectrum 410 from the monitored reflected spectrum 420. For example, the difference spectrum 430 may be generated by, for each value of wavelength, subtracting the value of intensity for that wavelength in the reference reflected spectrum 410 from the value of intensity for that wavelength in the monitored reflected spectrum 420.

FIGS. 4A-4D illustrate examples of difference spectra 430 that may be generated in different scenarios. One scenario that is not illustrated in FIGS. 4A-4D is if the reference reflected spectrum 410 and the monitored reflected spectrum 420 are the same, or sufficiently similar that the difference spectrum 430 is zero or substantially zero for all values of, for example, wavelength. Such a difference spectrum 430 may be detected by the processor 315 using conventional pattern recognition techniques.

In this scenario, the temperature and strain condition of the optical fibre 302 is considered to be unchanged. For example, if the reference reflected spectrum 410 is indicative of the optical fibre 302 in a steady-state condition, then the optical fibre 302 is determined to still be in the steady-state condition.

FIGS. 4A and 4B illustrate scenarios in which the temperature of the optical fibre 302 and/or the strain condition of the optical fibre 302 has changed when the monitored reflected spectrum 420 is sensed. In the example of FIG. 4A, the temperature of the optical fibre 302 has increased and/or the optical fibre 302 has a positive strain, i.e. the optical fibre 302 has extended. This temperature increase and/or extension of the optical fibre 302 produces a monitored reflected spectrum 420 in which the reflected wavelengths are increased compared to the reflected wavelengths, for example the peak wavelength in the monitored reflected spectrum 420 is higher than the peak wavelength in the reference reflected spectrum 410. In this scenario, the difference spectrum 430 calculated by subtracting the reference reflected spectrum 410 from the monitored reflected spectrum 420 may appear as shown in FIG. 4A. (It will be appreciated that, in forms where the difference spectrum 430 is calculated by subtracting the monitored reflected spectrum 420 from the reference reflected spectrum 410, the difference spectra 430 of FIGS. 4A and 4B will be inverted and the accompanying discussion should be altered accordingly). The difference spectrum 430 in FIG. 4A may be characterised as a spectrum in which positive values in the difference spectrum 430 (i.e. indicating wavelengths for which there is an increase in intensity from the reference reflected spectrum 410 to the monitored reflected spectrum 420) occur at higher wavelengths than negative values in the difference spectrum 430 (i.e. indicating wavelengths for which there is a decrease in intensity from the reference reflected spectrum 410 to the monitored reflected spectrum 420). The difference spectrum 430 in FIG. 4A may have an overall shape that may be considered sinusoidal-like.

In the example of FIG. 4B, the temperature of the optical fibre 302 has decreased and/or the optical fibre 302 has a negative strain, i.e. the optical fibre 302 has compressed. This temperature decrease and/or compression of the optical fibre 302 produces a monitored reflected spectrum 420 in which the reflected wavelengths are decreased compared to the reflected wavelengths, for example the peak wavelength in the monitored reflected spectrum 420 is lower than the peak wavelength in the reference reflected spectrum 410. In this scenario, the difference spectrum 430 calculated by subtracting the reference reflected spectrum 410 from the monitored reflected spectrum 420 may appear as shown in FIG. 4B. The difference spectrum 430 in FIG. 4B may be characterised as a spectrum in which positive values in the difference spectrum 430 (i.e. indicating wavelengths for which there is an increase in intensity from the reference reflected spectrum 410 to the monitored reflected spectrum 420) occur at lower wavelengths than negative values in the difference spectrum 430 (i.e. indicating wavelengths for which there is a decrease in intensity from the reference reflected spectrum 410 to the monitored reflected spectrum 420). The difference spectrum 430 in FIG. 4B may have an overall shape that may be considered sinusoidal-like, but inverted compared to the overall shape of the difference spectrum in FIG. 4A.

In certain forms, the processor 315 may be configured to analyse the difference spectrum to determine whether the sensed difference spectrum resembles the difference spectrum of FIG. 4A or FIG. 4B. The processor 315 may employ conventional pattern recognition techniques to determine whether the difference spectrum is of the type of FIG. 4A or FIG. 4B. In this way, the processor 315 may determine whether the optical fibre 302 is experiencing, or has experienced, a change in temperature and, if so, whether the temperature change is a temperature increase (in the case of FIG. 4A) or a temperature decrease (in the case of FIG. 4B), or whether the optical fibre 302 is experiencing, or has experienced, a strain and, if so, whether the strain is an extension (in the case of FIG. 4A) or a compression (in the case of FIG. 4B).

The scenarios illustrated in FIGS. 4A and 4B may occur for unsaturated spectra in a FBG 306. Different scenarios may occur in the situation in which the spectrum of the FBG 306 is saturated, for example if the peak region of the spectrum is saturated. A saturated spectrum of a FBG 306 means that some of the FBGs in the array, or some parts of the FBG 306, do not contribute to the overall reflected spectrum 314. This may be due to the fact that the incident light 310 with wavelengths at or close to the Bragg wavelength λ_{B} is strongly attenuated by the FBG 306. The additional presence of the insertion loss of FBG 306 means the reflected light in a downstream portion 320 of the optical fibre 302 may have a lower intensity than the noise of the reflected spectrum 314. In other words, in some forms of optical fibre 302, particularly optical fibres 302 having a relatively long length, some FBGs 306, or some portions of the FBG 306, may be in the shadow of the spectrum. In such forms, a change in the reflected spectrum 314 may only be perceptible when the reflected spectra affected by temperature and/or strain shift away from the saturated/shadow region. This scenario may be characterised as an addition to the intensity of the spectrum at certain wavelengths.

FIGS. 4C and 4D illustrate scenarios in which the temperature of the optical fibre 302 and/or the strain condition of the optical fibre 302 has changed when the monitored reflected spectrum 420 is sensed in the case of a saturated spectrum. In the example of FIG. 4C, the temperature of the optical fibre 302 has increased and/or the optical fibre 302 has a positive strain, i.e. the optical fibre 302 has extended. This temperature increase and/or extension of the optical fibre 302 produces a monitored reflected spectrum 420 in which there is an increase in intensity for some wavelengths higher than the peak wavelength. There may be no or little change in intensity for wavelengths less than the peak. In this scenario, the difference spectrum 430 calculated by subtracting the reference reflected spectrum 410 from the monitored reflected spectrum 420 may appear as shown in FIG. 4C. (Again it will be appreciated that, in forms where the difference spectrum 430 is calculated by subtracting the monitored reflected spectrum 420 from the reference reflected spectrum 410, the difference spectra 430 of FIGS. 4C and 4D will be inverted and the accompanying discussion should be altered accordingly). The difference spectrum 430 in FIG. 4C may be characterised as a spectrum in which there are a range of positive values in the difference spectrum 430.

In the example of FIG. 4D, the temperature of the optical fibre 302 has decreased and/or the optical fibre 302 has a negative strain, i.e. the optical fibre 302 has compressed. This temperature decrease and/or compression of the optical fibre 302 produces a monitored reflected spectrum 420 in which there is an increase in intensity for some wavelengths lower than the peak wavelength. There may be no or little change in intensity for wavelengths greater than the peak. In this scenario, the difference spectrum 430 calculated by subtracting the reference reflected spectrum 410 from the monitored reflected spectrum 420 may appear as shown in FIG. 4D. The difference spectrum 430 in FIG. 4D may be characterised as a spectrum in which there are a range of positive values in the difference spectrum 430.

In certain forms, the processor 315 may be configured to analyse the difference spectrum to determine whether the sensed difference spectrum resembles the difference spectrum of FIG. 4C or FIG. 4D. However, it is considered to be difficult for a processor 315 to be able to distinguish the difference spectrum 430 in the scenario of FIG. 4C from the difference spectrum 430 in the scenario of FIG. 4D because the two difference spectra look alike and would look more similar in a practical situation where the spectra are noisy and imperfect. Consequently, in certain forms of the technology, the processor 315 may be configured to analyse the difference spectrum to determine whether the sensed difference spectrum resembles the difference spectrum of FIG. 4C or FIG. 4D as compared to the difference spectrum of FIG. 4A or the difference spectrum of FIG. 4B. That is, the processor 315 may analyse the difference spectrum to determine which of the following three options the difference spectrum most closely resembles: 1) that of FIG. 4A (indicating a temperature increase/positive strain); 2) that of FIG. 4B (indicating a temperature decrease/negative strain); or 3) that of FIG. 4C or 4D. In the case of a determination that the difference spectrum resembles that of FIG. 4C or 4d, the processor 315 may be configured to perform additional analysis to determine whether the difference spectrum is indicative of a temperature increase or decrease, or a positive or negative strain. The processor may employ conventional pattern recognition techniques to characterise the type of difference spectrum detected.

In a further possible scenario, the processor 315 may analyse the difference spectrum 430 and determine that multiple patterns are present, for example using conventional pattern recognition techniques. For example, the difference spectrum 430 may comprise any two or more of the types of pattern shown in FIGS. 4A, 4B, 4C and 4D. Consequently, in certain forms of the technology, the processor 315 may be configured to analyse the difference spectrum 430 to determine which of the following four options applies: 1) the difference spectrum most closely resembles the difference spectrum of FIG. 4A (indicating a temperature increase/positive strain); 2) the difference spectrum most closely resembles the difference spectrum of FIG. 4B (indicating a temperature decrease/negative strain); 3) the difference spectrum most closely resembles the difference spectrum of FIG. 4C or 4D; or 4) the difference spectrum includes a plurality of patterns resembling any one or more of FIGS. 4A, 4B and 4C or 4D. In the case of the fourth option, the processor 315 may determine which of the patterns of FIGS. 4A, 4B and 4C or 4D are present in the difference spectrum and, in some forms, at which wavelengths the respective patterns appear.

### 6.3.2. Noise Threshold

It is noted that the waveforms and graphs shown in FIGS. 4A-4D are simplifications and, in a practical implementation of the technology, the reflected spectra 314 detected by the sensor 313 will contain noise. In certain forms of the technology, a measurement of noise in the spectra may be made so that the features of any detected spectra can be compared to the noise level and treated accordingly. For example, in certain forms, the processor 315 may be configured to determine whether the measurements (e.g. intensities) in the difference spectrum exceed a noise threshold, and the processor 315 may be configured to only analyse the difference spectrum if the noise threshold is exceeded. If not, the difference spectrum may not be analysed. The measurement of the noise may be performed prior to any monitoring steps. Noise may also be measured subsequently.

In certain forms, the level of noise in the reflected spectra 314 received by the sensor 313 may be determined while the optical fibre 302 is at a steady-state temperature and strain condition. For example, one or more samples of reflected spectra 314 may be taken during a period of normal, stable operation of the FBG sensing system 300 to determine a noise spectrum. In certain forms, a plurality of reflected spectra 314 may be sensed over a period of time when the optical fibre 302 is at a steady-state temperature and strain condition and the noise spectrum may be determined from the plurality of reflected spectra 314. For example, the noise spectrum may be determined as the maximum intensity in the difference spectrum 430 for each wavelength sensed during that period of time. In other forms, the noise spectrum may be determined as some measure of an average of the intensities in the difference spectrum 430 for each wavelength sensed during that period of time, e.g. the mean or 75^{th} percentile value of the measured intensity for each wavelength.

The noise spectrum may subsequently serve as an indication of the noise threshold. For example, any given difference spectrum 430 may be determined to exceed the noise threshold if the values in the difference spectrum 430 exceed those variations that might be expected through noise variations alone. For example, in some forms, the difference spectrum 430 may be directly compared to the noise spectrum.

### 6.3.3. Further Analysis to Determine Change of Temperature/Strain

It has been explained that, in the case of the difference spectrum 430 being indicative of a saturated spectrum (e.g. in the case of the scenarios shown in FIGS. 4C and 4D), the processor 315 may not be able to distinguish between a difference spectrum indicative of a temperature increase/positive strain (as per FIG. 4C) and a difference spectrum indicative of a temperature decrease/negative strain (as per FIG. 4D) using conventional pattern recognition techniques applied to the difference spectrum alone. Similarly, in the case of the difference spectrum 430 including a plurality of the patterns shown in FIGS. 4A to 4D, particularly if the plurality of patterns includes either or both of the patterns of FIGS. 4C and 4D indicated of a saturated spectrum, the processor 315 may not be able to distinguish between a pattern indicative of a temperature increase/positive strain and a pattern indicative of a temperature decrease/negative strain using conventional pattern recognition techniques applied to the difference spectrum alone. This section describes additional analysis that the processor 315 may undertake to determine a change in temperature/strain and, if so, the direction of the change/strain in certain forms of the technology.

In some forms, the additional analysis described in this section may be undertaken if it is determined that the difference spectrum 430 is indicative of a saturated spectrum and/or if it is determined that the difference spectrum 430 includes a plurality of patterns such as those shown in FIGS. 4A to 4D. In alternative forms, the additional analysis may also be undertaken in other eventualities, for example upon detection of the difference spectra of the types shown in FIGS. 4A and 4B. In such forms, the additional analysis may be useful, or necessary, to determine the magnitude of the change in temperature/strain and consequently whether the change is worth signalling, for example whether it may be indicative of a quench in a length of superconducting material.

In certain forms, additional analysis that is performed by the processor 315 may be the determination of a measure of spectral change of the monitored reflected spectrum 420 during monitoring. In certain forms, the measure of spectral change may be determined by monitoring a characteristic of the monitored reflected spectrum 420 and determining the measure of spectral change from change (or lack of change) to the characteristic over time. For example, if the characteristic remains substantially similar over time, the measure of spectral change may be determined to be low, for example zero.

In certain forms, the characteristic may be an average of the monitored reflected spectrum 420. Any parameter indicative of an average value of the monitored reflected spectrum 420 may be used in different forms of the technology. In certain forms, the average value may be the centroid of the monitored reflected spectrum 420, and the centroid λ̅(t) may be calculated using the equation:

$$\overline{λ} ( t ) = \frac{\sum I ( {λ}_{i} , t ) {λ}_{i}}{\sum I ( {λ}_{i} , t )}$$

It is considered that the centroid is a useful measure of the average of the reflected spectrum 314 because it can be calculated quickly and efficiently. In other forms, another measure of the average of the monitored reflected spectrum 420 may be used, for example the mean etc. The measure of the average may be considered to be a measure of spectral change since, if the measure of the average changes, this indicates a change in the spectrum.

Any measure indicative of a spectral change of the monitored reflected spectra 420 may be used in different forms of the technology. In certain forms, the spectral change may be equivalent to, or determined from, the integral of the absolute difference spectrum, and the change factor C, may be calculated using the equation:

$$C = {\int }_{{λ}_{1}}^{{λ}_{2}} \vert {I}_{λ , t} - {I}_{λ , r} \vert d λ$$

In other forms, the spectral change may be equivalent to, or determined from, the sum of the absolute spectral intensity change for each wavelength, and the change factor C, may be calculated using the equation:

$$C = {\sum }_{λ = 1}^{n} \vert {I}_{λ , t} - {I}_{λ , r} \vert$$

In other forms, another measure of the spectral change of the monitored reflected spectrum 420 may be used, for example the spectral correlation, spectral angle, spectral similarity, etc.

In certain forms, a plurality of monitored reflected spectra 420 are analysed to determine the measure of spectral change, for example multiple consecutive or sequential monitored reflected spectra 420 may be analysed in this way. The processor 315 may analyse the measures of spectral change indicative of this plurality of reflected spectra 420 and determine whether these measures are indicative of a temperature change and/or a change in strain condition and, if so, whether there is an increase or decrease of the temperature/strain. An indication that there is a spectral change in one direction, for example an increase in the measure of average, for example the centroid, may be indicative of an increase in temperature and/or strain and a decrease in the measure of average may be indicative of a decrease in temperature and/or strain. In addition, the rate of spectral change, for example the rate of increase or decrease, may be determined by the processor 315 and this may indicate the rate of temperature and/or strain increase or decrease.

Alternatively, in certain forms, the processor 315 may be able to determine whether there is a temperature increase or decrease and/or a strain extension or contraction from the shape of the difference spectrum 430 (for example if the difference spectrum includes a pattern such as shown in FIGS. 4A and 4B) but the processor 315 may analyse a plurality of monitored reflected spectra 420 to determine the measure of spectral change, and consequently to determine a magnitude of the change in temperature and/or strain.

In some forms, the processor 315 may be configured to detect a possible impending quench in a length of superconducting material if there is detected an increase in temperature and/or strain in an optical fibre 302 in thermal contact with the length of superconducting material. Additionally, or alternatively, the processor 315 may be configured to detect a possible impending quench in a length of superconducting material if the change in temperature and/or strain exceeds a threshold, for example if the magnitude of the increase and/or the rate of increase exceeds a certain threshold and/or if the increase of the rate of increase exceeds a certain threshold. Additionally, or alternatively, the processor 315 may be configured to generate a signal, for example an alert, in such a situation.

In other forms, further analysis may be performed on the monitored reflected spectrum 420 to detect a change in temperature and/or strain, and optionally to determine whether the change is an increase or decrease, in accordance with the methods described in PCT Patent Application No. PCT/NZ2019/050075 (published as PCT Publication No. WO 2020/005077), the contents of which are herein incorporated by reference in their entirety.

### 6.3.4. Sub-Set of Monitored Reflected Spectrum

In certain forms, additional analysis may not be performed on the full monitored reflected spectrum 420 since this may not be needed in order to detect a change and determine the nature of the detected change, and may therefore be inefficient. Instead, the processor 315 may be configured to identify a sub-set of the monitored reflected spectrum 420 and to perform further analysis on the sub-set. The sub-set of the monitored reflected spectrum 420 may be referred to as a window.

For example, in certain forms, the processor 315 may be configured to identify the sub-set as the range or ranges in the monitored reflected spectrum 420 through which the magnitude of the corresponding difference spectrum 430 exceeds some threshold. In certain forms, this threshold may be a noise threshold, for example the noise threshold described above, i.e. the measure of the maximum intensity of noise for each wavelength measured over the duration of a noise detection period.

In certain forms, the determination of the measure of spectral change of the monitored reflected spectrum 420, for example determination of the measure of the average of the monitored reflected spectrum 420, may only be performed for the range or ranges of the monitored reflected spectrum 420 that corresponds to this range or ranges in the difference spectrum 430. In this way, the further analysis that may be needed to be conducted to detect a change and to determine the nature of the detected change, may be performed more quickly and efficiently than if the further analysis was conducted on the full monitored reflected spectrum 420. In this way, the signal-to-noise ratio (SNR) can be increased by excluding the noise of the parts of spectrum that do not respond to a temperature/strain change. In some forms, the measures of spectral change for each of the ranges of the monitored reflected spectrum 420 may be summed in some way in order to calculate a summed measure of spectral change for the monitored reflected spectrum 420.

### 6.3.5. Exemplary Detection Method

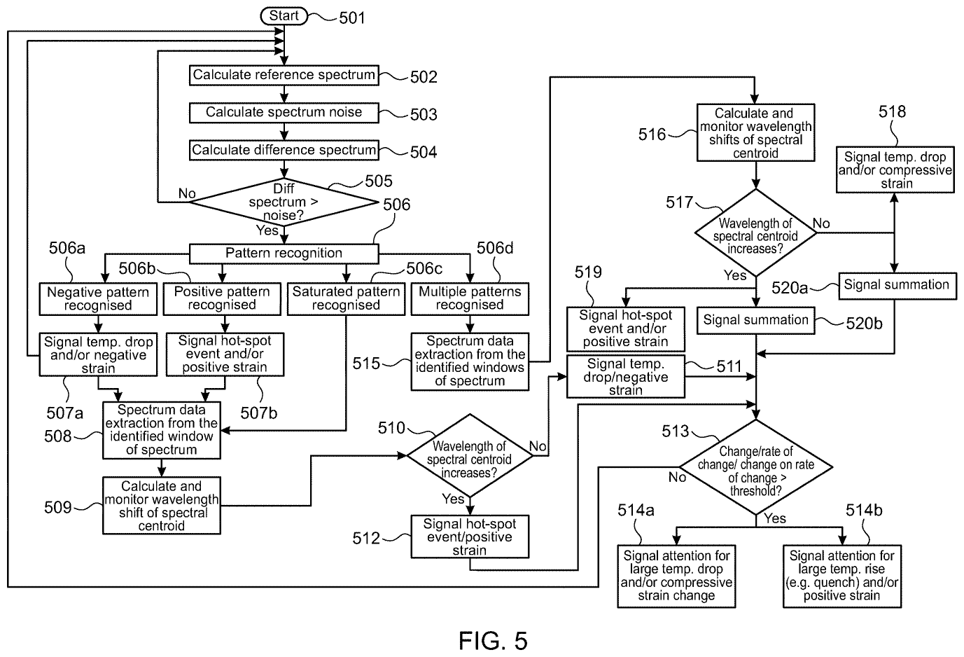

An exemplary method of sensing a change in temperature and/or strain in an optical fibre 302, and consequently detecting an impending quench in a length of superconducting material will now be described with reference to FIG. 5, which is a flow chart illustrating such an exemplary method 500. In certain forms, the exemplary method 500 is performed by processor 315.

Method 500 will also be explained with reference to data from certain experiments that were performed to demonstrate the operation of certain exemplary forms of the technology. In the experiments, quasi-continuous FBGs were inscribed into the core of a single mode and germanium-doped silica optical fibres 302. The optical fibres 302 were coated with Ormocer® to provide superior mechanical strength and be suited for applications in extreme environments, e.g. cryogenics. Three optical fibres with 20, 50 and 190 FBGs (sensing length of 0.2, 0.5 and 1.9 m, respectively) were used to detect the event of temperature change at room and cryogenic temperatures. The fibres will be referred to as ULFBG1, ULFBG2 and ULFBG3 respectively. Each FBG was 9 mm long and the space between two adjacent FBGs along the length of the respective optical fibre 302 was 1 mm.

The ends of ULFBG2 and ULFBG3 were mounted in a V-shaped groove of a 30×30×3 mm copper plate with Apiezon N at 293 K. A resistive heater was mounted on top of the copper plate to heat up three out of 50 and 190 FBGs in ULFBG2 and ULFBG3 respectively. This was followed by placing a cold copper plate (cooled using liquid nitrogen) on the heater to cool the copper down to below its initial temperature. Finally, another heat pulse from the heater was used to raise the temperature to above 293 K, which stabilised over time. This alternating variation in temperature was used to examine the capability of the exemplary method 500 to detect the direction of temperature change. A Pt100 platinum resistance temperature detector (class A) was attached to the host copper plate with Apiezon N to monitor the temperature fluctuation. This experiment aimed to demonstrate the difference spectra 430 from unsaturated ULFBG2 and saturated ULFBG3.

ULFBG1 was fully mounted in a V-shaped groove of a copper plate and stored in a cryostat. The temperature of the host copper was maintained at about 80 K before a heat pulse was induced from a resistive heater on one end of the copper. A Pt100 mounted next to the beginning of the ULFBG1 detected the time when the heat pulse reached the sensor. Due to the strain distribution at cryogenic temperatures, the spectrum was distorted, which provided a realistic dataset for verifying the effectiveness of the exemplary method 500.

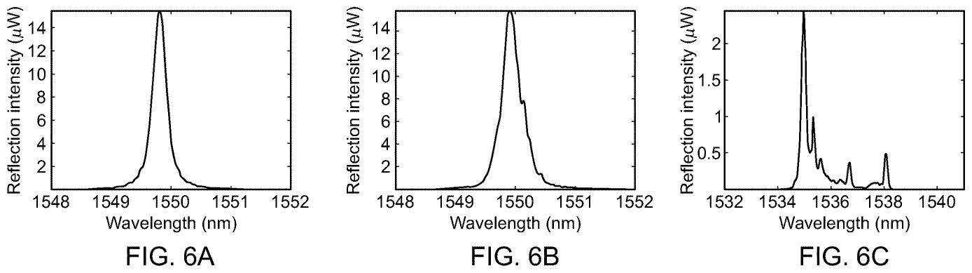

The method 500 begins at step 501. At step 502, the reference reflected spectrum 410 may be determined, for example in the manner described above. FIGS. 6A, 6B and 6C are graphs of exemplary reference reflected spectra 410 for ULFBG1, ULFBG2 and ULFBG3 respectively obtained through the experiments described above.

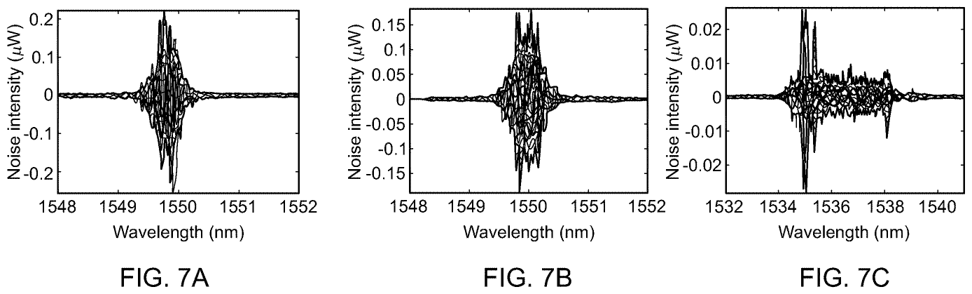

At step 503 of exemplary method 500, processor 315 determines a noise spectrum, for example in the manner explained earlier. FIGS. 7A, 7B and 7C are graphs of exemplary noise spectra obtained from ULFBG1, ULFBG2 and ULFBG3 respectively. These figures illustrate that, in these experiments, the maximum noise in the noise spectra occurred at the peaks of the spectra. The magnitude of the maximum noise varies between 0.15 and 0.25 μW.

After step 503, the monitoring of the optical fibre 302 commences. Subsequent steps should be understood to occur on a frequent (e.g. regular) ongoing basis during the monitoring period. At step 504, the processor 315 obtains a monitored reflected spectrum 420 and determines a difference spectrum 430 from the monitored reflected spectrum 420 and the reference reflected spectrum 410, for example using the method explained above.

At step 505, processor 315 determines whether the difference spectrum 430 exceeds a noise threshold, for example using the method explained above. If not, the method returns to an earlier step, for example the method 500 may return to the step 501 of calculating the reference spectrum. In other forms, the method may not re-calculate the reference spectrum but may instead return to step 504 of calculating the difference spectrum. In some forms, the method 500 may return to step 501 regularly, e.g. periodically. If the difference spectrum 430 is determined to exceed the noise threshold, then the method 500 proceeds to step 506.

At step 506, the processor 315 conducts pattern recognition on the difference spectrum 430. As explained earlier, conventional pattern recognition techniques may be used in order to detect one or more patterns of the types illustrated in FIGS. 4A-D, for example using Matlab. Possible outcomes of the pattern recognition step 506 are illustrated as steps 506a, 506b, 506c and 506d. In step 506a, a “negative” pattern is recognised, i.e. a pattern such as illustrated by way of example in FIG. 4B that may be illustrative of a temperature decrease and/or negative strain in the optical fibre 302. In step 506b, a “positive” pattern is recognised, i.e. a pattern such as illustrated by way of example in FIG. 4A that may be illustrative of a temperature increase and/or positive strain in the optical fibre 302. In step 506c, a pattern indicative of a saturated spectrum may be detected, i.e. a pattern such as illustrated by way of example in FIGS. 4C and 4D. In step 506d, a plurality of patterns may be detected.

In the case of the detection of negative and positive patterns, i.e. steps 506a and 506b, the method 500 moves to steps 507a and 507b respectively. In these steps, the processor 315 may signal the findings corresponding with the pattern detected, e.g. signalling a temperature drop and/or negative strain at step 507a in the case of detection of a negative pattern at step 506a and signalling a temperature increase (or “hot-spot”) and/or positive strain at step 507b in the case of detection of a positive pattern at step 506b. The processor 315 may generate these signals, and other signals as will be described in the following description, in any suitable way, for example by sending a message to any one or more client devices, such as display device 414, tablet computer 418a, personal computer 418b, and/or smartphone 418c such as shown in FIG. 2, and causing an alert to be generated on such devices.

After performing steps 507a or 507b or, if the saturated pattern is recognised at step 506c, the method 500 may perform step 508. In step 508, a sub-set of the data representative of the monitored reflected spectrum 420 may be extracted. As explained earlier, in some forms, the sub-set of the monitored reflected spectrum 420 that is extracted may be the part of the spectrum that corresponds to the part or parts of the monitored reflected spectrum 420 in which the magnitude of the corresponding difference spectrum 430 exceeds a threshold, e.g. the noise threshold.

At step 509, the processor 315 calculates a measure of a spectral change from the sub-set of the data in the monitored reflected spectrum 420 that is extracted in step 508. For example, a measure of an average of that sub-set, for example the centroid of the sub-set of the data may be determined, as explained earlier. Step 509 may further involve monitoring for spectral change in, for example monitoring of the centroid of, the sub-set of the data over one or more subsequent monitoring steps.

In step 510, the processor 315 determines whether the spectral change is an increase or decrease, for example whether the measure of the average that is determined in step 509, e.g. the centroid of the wavelength, increases or decreases. If it is determined that the spectral change is negative, e.g. the centroid has decreased, then the processor 315 determines that there is a temperature decrease and/or a negative strain (i.e. compression). If it is determined that the spectral change is positive, e.g. the centroid has increased, then the processor 315 determines that there is a temperature increase and/or a positive strain (i.e. expansion). Processor 315 may generate a signal indicating the relevant determination at steps 511 and 512 respectively, for example in the manner of the signals explained earlier in relation to steps 507a and 507b. These additional determination and signalling steps (i.e. steps 510, 511 and 512) may not be necessary in the case of the negative or positive patterns being recognised in steps 506a or 506b, and if the temperature or strain change have already been signalled in steps 507a or 507b. For example, these steps may not be necessary if the optical fibre 302 is configured to avoid the spectrum saturating, as explained earlier. In such forms, step 509 may be proceeded by step 513 directly.

In step 513, the processor 315 determines whether the magnitude of the spectral change, for example the change in the measure of the average, e.g. the centroid, calculated in step 509 exceeds a predetermined threshold and/or whether the rate of change in the spectral change (e.g. measure of the average, e.g. the centroid) calculated in step 509 exceeds a predetermined threshold and/or whether a change in the rate of change in the spectral change (e.g. measure of the average, e.g. the centroid) calculated in step 509 exceeds a predetermined threshold. The predetermined thresholds may be set based on earlier experimental data for the system being monitored. The predetermined thresholds may be set according to the desired degree of sensitivity of the monitoring system and the thresholds may be able to be altered in order to adjust the sensitivity of the monitoring system.

If one or more of the thresholds are not exceeded, then it is considered that the detected temperature change is not sufficiently great and/or rapid to generate a warning and the method 500 returns to an earlier step, for example step 502 or step 504. If one or more of the thresholds are exceeded, then it is considered that the detected temperature change is sufficiently great and/or rapid to generate a warning and, depending on the direction of the change, step 514a or 514b may be performed. Step 514a occurs if a reduction in temperature is determined and/or if a negative strain (i.e. compression) is determined and the magnitude of the change and/or the rate of change and/or the change in the rate of change of the spectral change (e.g. centroid) exceeds the threshold. Step 514b occurs if an increase in temperature is determined and/or if a positive strain (i.e. expansion) is determined and the magnitude of the change and/or the rate of change and/or the change in the rate of change of the spectral change (e.g. centroid) exceeds the threshold. Processor 315 may generate a signal indicating the relevant determination, for example in the manner of the signals explained earlier in relation to steps 507a and 507b. In the case of a system monitoring a length of superconducting material and in the event of determination of a sufficiently large and/or fast temperature increase and/or determination of a sufficiently large and/or fast positive strain change, a quench event warning may be signalled.

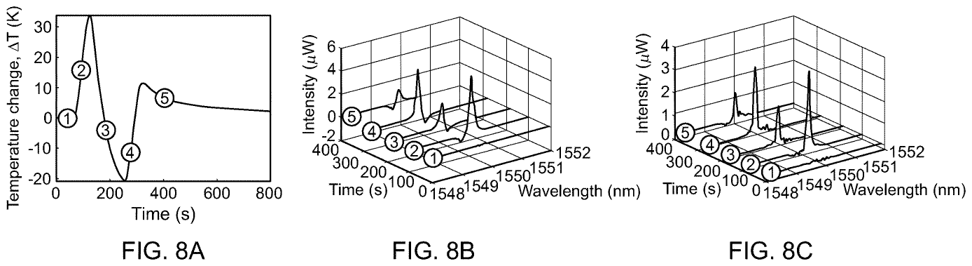

FIG. 8A illustrates the variation in temperature over time of the copper block onto which the 30 mm of ULFBG2 and ULFBG3 are mounted in the previously described experiments. FIGS. 8B and 8C illustrate the difference spectra 430 of ULFBG2 and ULFBG3 respectively at the times marked 1-5 in FIG. 8A. The five difference spectra 430 in each of FIGS. 8B and 8C correspond to the temperature changes of 0, 16 K, −3 K, −11 K and 6 K, as shown in FIG. 8A. At the time marked 1, when the temperature remains unchanged, the difference spectra in both ULFBGs shows effectively no signal, with only a little fluctuation about the Bragg wavelength, which is caused by the noise of the spectra. At the times marked 2 and 5, where the temperatures are above the reference temperature at time 1, positive difference spectrum patterns (e.g. similar to the pattern shown in FIG. 4A) are recognised in ULFBG2 in FIG. 8B. In contrast, at the times marked 3 and 4, when the temperatures fall below the reference temperature, negative difference spectrum patterns (e.g. similar to the pattern shown in FIG. 4B) are shown in the same optical fibre in FIG. 8B. The positive and negative patterns in FIG. 8B also indicate that the spectrum of ULFBG2 is not saturated although the spectra of 50 FBGs are superimposed about the same Bragg wavelength. In contrast, as shown in FIG. 8C, for ULFBG3, which contains 190 FBGs with the same Bragg wavelength, only saturated patterns may be found throughout the temperature fluctuation. It is noted that only one type of difference spectrum pattern is found in each of ULFBG2 and ULFBG3 as the temperature changes. This may be because there was no strain or temperature distribution across the 30 mm FBGs in the experiment under the heater, and the size of the hot spot was fixed to be 30 mm. It is also observed that both the width and maximum intensity change of difference spectrum patterns in ULFBG2 (as shown in FIG. 8B) are greater than those for ULFBG3 (as shown in FIG. 8C). This is due to the fact that ULFBG3 has a greater number of FBGs in the array, which results in a spectrum closer to saturation. This means the spectral changes are smaller in magnitude.

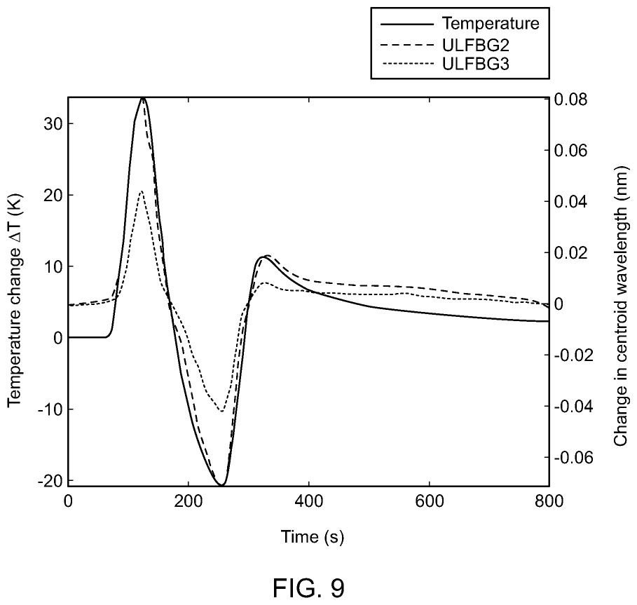

The wavelength boundaries of the difference spectrum patterns further determine the window of the sub-set of spectral data for calculating the measure of spectral change, for example the measure of the average, e.g. the wavelength shift of the centroid, which is the final detection signal. FIG. 9 illustrates the change in the determined centroid wavelength over time on the same graph as the change in temperature over time for the FBG samples ULFBG2 and ULFBG3 of the conducted experiment. It can be seen from FIG. 9 that the wavelength shift of the spectral centroid of ULFBG2 and ULFBG3 followed the temperature fluctuation closely. Due to the higher number of FBGs in the array of ULFBG3, its signal-to-noise ratio (SNR) for the same hot spot is lower than that of ULFBG2. Nevertheless, the direction of temperature change in ULFBG3, that may be difficult to identify using the difference spectrum patterns in FIG. 8C due to the saturation effect, may now be seen in the change in the centroid as shown in FIG. 9.

Returning to method 500 of FIG. 5, step 515 is performed by the processor 315 if multiple patterns are recognised in the difference spectrum 430 at step 506d. Step 515 may be similar to step 508, i.e. a sub-set of the data representative of the monitored reflected spectrum 420 may be extracted. As explained earlier, in some forms, the sub-set of the monitored reflected spectrum 420 that is extracted may be the part of the spectrum that corresponds to the part or parts of the monitored reflected spectrum 420 in which the magnitude of the corresponding difference spectrum 430 exceeds a threshold, e.g. the noise threshold.

Next, step 516 may be performed by the processor 315. Step 516 may be similar to step 509, i.e. the processor 315 may calculate a measure of spectral change in, e.g. a measure of an average of, the sub-set of the data in the monitored reflected spectrum 420 that is extracted in step 515, only in step 516 this calculation may occur for each of the sub-sets of the data corresponding to each of the multiple patterns recognised in step 506d. For example, the centroid of each sub-set of the data may be determined, in accordance with the process explained earlier. Step 516 may further involve monitoring for spectral change in, e.g. monitoring of the centroids of, the sub-sets of the data over one or more subsequent monitoring steps.

Next, step 517 may be performed by the processor 315. Step 517 may be similar to step 510, i.e. the processor 315 may determine whether there is a spectral change and whether it is positive or negative, e.g. whether each of the plurality of measures of the average that are determined in step 516, e.g. the centroids of the wavelength, increases or decreases. If it is determined that there is negative spectral change, e.g. one of the respective centroids has decreased, then the processor 315 determines that there is a temperature decrease and/or a negative strain (i.e. compression). If it is determined that there is positive spectral change, e.g. one of the respective centroids has increased, then the processor 315 determines that there is a temperature increase and/or a positive strain (i.e. expansion). Processor 315 may generate a signal indicating the relevant determination at steps 518 and 519 respectively, for example in the manner of the signals explained earlier in relation to steps 507a and 507b. In addition to performing steps 518 and 519, whether the spectral change is positive or negative, e.g. whether the measure of the average is determined to increase or decrease, the processor 315 may perform a signal summation step, i.e. step 520a or step 520b. In an example of the signal summation step 520, the plurality of measures of the spectral change that are calculated in step 516 for each of the sub-sets of data in the monitored reflected spectrum 420, corresponding to each of the plurality of patterns recognised at step 506d, are summed together in some manner to calculate a summed measure of spectral change. In some forms, this sum may be a simple sum of the values, while in other forms another type of some may be performed, for example a weighted sum. In some forms, the summed measure of spectral change may be a summed measure of the average of the monitored reflected spectrum.

The value of the sum is output at step 520a or 520b and this sum is provided as the input to step 513, from which method 500 proceeds in the manner explained above, only applied to the summed measures of the average.

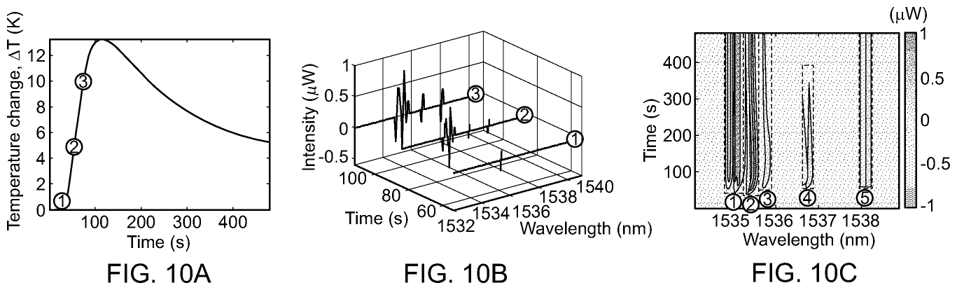

FIG. 10A is a graph indicating the progress in temperature change over time for the optical fibre ULFBG1 in the above-described experiment. At time points 1, 2 and 3, the maximum temperature increase is 0.5 K, 5 K, and 10 K respectively, with a starting temperature of 80 K. FIG. 10B is an illustration of the difference spectrum 430 at each of time points 1, 2 and 3. FIG. 10B shows that, as the hot spot reaches the beginning of the sensor, the first positive difference spectrum pattern is observed (time point 1 in FIG. 10B). As the heat pulse propagates further, the subsequent FBGs are influenced and thus more positive difference spectrum patterns appear in FIG. 10B. Since the FBGs are at different strain states, the positive difference spectrum patterns appear randomly in the wavelength domain. The difference spectrum pattern evolution of ULFBG1 due to the heat pulse propagation is shown in the 2D colour map of FIG. 10C. Five positive difference spectrum patterns are clustered in FIG. 10C. As the heat pulse propagates along the array of FBGs, the front FBGs respond earlier than the rear FBGs. In this case, the clusters marked 2 and 5 in FIG. 10C respond the earliest and latest respectively. It is also shown that the positive difference spectrum patterns vary in shape with the wavelength location due to the distorted spectrum.

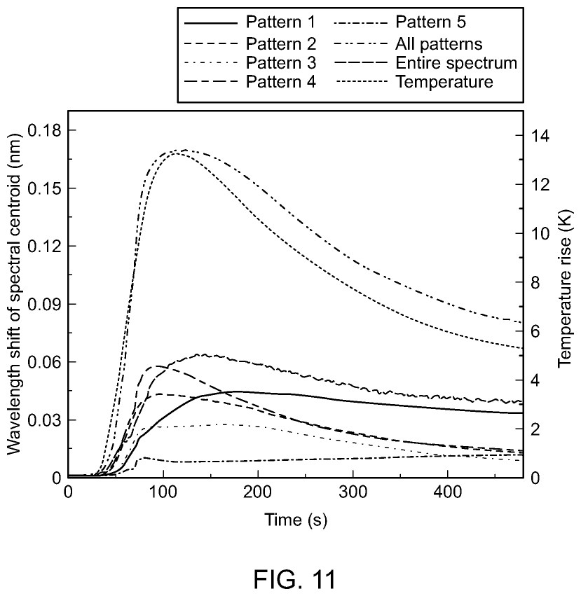

FIG. 11 illustrates the wavelength shift of the spectral centroids against time for each of the five sub-sets of spectral data (labelled as patterns 1 to 5 respectively) and the sum of these five centroids (labelled as ‘All patterns’). It can be seen from FIG. 11 that the variation of the sum of the five centroids with time corresponds well to the maximum temperature change, which is also plotted on FIG. 11 and labelled as ‘Temperature’. The wavelength shift of the entire spectrum's centroid is also plotted for comparison (labelled as “Entire spectrum”). FIG. 11 indicates that, by only determining the measure of the average for the spectral changes in the sub-sets where the difference spectrum exceeds the noise threshold, the detection signal is, in this example, about three times higher than the signal processed from the entire spectrum (comparing ‘All patterns’ and ‘Entire spectrum’ in FIG. 11). Due to the reduced noisy spectral data, the wavelength shift of the spectral centroid is also less noisy. In addition, using the proposed method 500, ULFBG1 is shown to respond as fast as a Pt100 sensor, which has a response time of about 100 ms, within a 0.5 K temperature rise.

### 6.4. Other Remarks

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. A processor-implemented method of sensing a change in temperature and/or strain in an optical fibre comprising a substantially continuous or quasi-continuous fibre Bragg grating, the method comprising:
receiving a reference reflected spectrum indicative of a reference reflection by the fibre Bragg grating of incident light provided into an end of the optical fibre;
receiving a monitored reflected spectrum, wherein the monitored reflected spectrum is detected by the sensor from reflection by the fibre Bragg grating of incident light provided into the end of the optical fibre during monitoring;
determining a difference spectrum between the reference reflected spectrum and the monitored reflected spectrum; and
analysing the difference spectrum to determine whether the optical fibre is experiencing a change of type a) or b),
wherein a) is a temperature increase or an extension, and
wherein b) is a temperature decrease or a contraction.

2. A processor-implemented method as claimed in 1, wherein analysing the difference spectrum comprises detecting a shape of the difference spectrum and determining from the shape of the difference spectrum whether the change is type a) or b).

3. A processor-implemented method as claimed in claim 1, wherein the method further comprises determining a measure of spectral change of the monitored reflected spectrum and using the measure of spectral change to determine whether the change is type a) or b).

4. A processor-implemented method as claimed in claim 3, wherein the method further comprises determining a rate of spectral change of the monitored reflected spectrum and using the rate of spectral change to determine a rate of temperature change and/or a rate of strain change.

5. A processor-implemented method as claimed in claim 3, wherein the method further comprises determining a measure of an average of the monitored reflected spectrum and using the measure of the average to determine whether the change is type a) or b).

6. A processor-implemented method as claimed in claim 5, wherein the method further comprises determining a direction of change of the measure of the average of the monitored reflected spectrum to determine whether the change is type a) or b).

7. A processor-implemented method as claimed in claim 3, wherein the method further comprises determining the measure of spectral change from a sub-set of the monitored reflected spectrum.

8. A processor-implemented method as claimed in claim 7, wherein the sub-set of the monitored reflected spectrum comprises one or more ranges in the monitored reflected spectrum through which the magnitude of the corresponding difference spectrum exceeds a noise threshold.

9. A processor-implemented method as claimed in claim 8, wherein, if the difference spectrum is determined to comprise a plurality of ranges in the monitored reflected spectrum through which the magnitude of the corresponding difference spectrum exceeds the noise threshold, the method further comprises determining the measure of spectral change for each of the ranges in the monitored reflected spectrum.

10. A processor-implemented method as claimed in claim 9, wherein the method further comprises performing a sum of each of the measures of spectral change to calculate a summed measure of spectral change.

11. A processor-implemented method as claimed in claim 3, wherein the method further comprises determining the measure of spectral change if the difference spectrum is determined to be indicative of a saturated spectrum.

12. A processor-implemented method as claimed in claim 1, wherein the method further comprises signalling the change.

13. (canceled)

14. A processor-implemented method as claimed in claim 1, wherein the reference reflected spectrum is indicative of reflection of the incident light when the optical fibre is in a steady-state temperature and strain condition.

15. A processor-implemented method as claimed in claim 1, wherein the step of analysing the difference spectrum is performed if the difference spectrum exceeds a noise threshold.

16. (canceled)

17. An optical fibre sensing system comprising:
an optical fibre comprising a substantially continuous or quasi-continuous fibre Bragg grating;
a light source for providing incident light to an end of the optical fibre; and
a sensor for detecting a reflected spectrum of the incident light from the optical fibre; and
a processor configured to monitor the optical fibre by performing a method comprising:
receiving a reference reflected spectrum of the incident light from the optical fibre;
receiving a monitored reflected spectrum of the incident light from the optical fibre;
determining a difference spectrum between the reference reflected spectrum and the monitored reflected spectrum; and
analysing the difference spectrum to determine whether the optical fibre is experiencing a change of type a) or b),
wherein a) is a temperature increase or an extension, and
wherein b) is a temperature decrease or a contraction.

18. An optical fibre sensing system as claimed in claim 17, wherein the fibre Bragg grating has a grating period that is substantially the same along the length of the optical fibre when the optical fibre is in a steady-state temperature and strain condition.

19. An optical fibre sensing system as claimed in claim 17, wherein the fibre Bragg grating has a grating period that varies along the length of the optical fibre when the optical fibre is in a steady-state temperature and strain condition.

20. An optical fibre sensing system as claimed in claim 17, wherein the fibre Bragg grating has a reflectivity that is the same along the length of the optical fibre when the optical fibre is in a steady-state temperature and strain condition.

21. An optical fibre sensing system as claimed in claim 17, wherein the fibre Bragg grating has a reflectivity that varies along the length of the optical fibre when the optical fibre is in a steady-state temperature and strain condition.

22. An optical fibre sensing system as claimed in claim 21, wherein the optical fibre comprises a quasi-continuous fibre Bragg grating comprising a plurality of fibre Bragg gratings, each separated by a gap, wherein the size of the gap varies along the length of the optical fibre.
